(19) United States
(12) Patent Application Publication
(10) Pub. No.: US 2026/0024507 A1
(43) Pub. Date: Jan. 22, 2026

(54) FRAME DISPLAY METHOD AND FRAME GENERATION DEVICE

(71) Applicant: MEDIATEK INC., Hsinchu City (TW)

(72) Inventors: Yi-Hsin Shen, Hsinchu City (TW); Nien-Hsien Lin, Hsinchu City (TW); Chiu-Jen Lin, Hsinchu City (TW); Cheng-Che Chen, Hsinchu City (TW)

(73) Assignee: MEDIATEK INC., Hsinchu City (TW)

(21) Appl. No.: 19/270,494

(22) Filed: Jul. 16, 2025

Related U.S. Application Data
(60) Provisional application No. 63/672,277, filed on Jul. 17, 2024.

(51) Int. Cl. G09G 5/00

(52) U.S. Cl. CPC G09G 5/003; G09G 2320/0247; G09G 2320/0252; G09G 2340/16

(57) ABSTRACT

A frame display method, applied to a frame display device, comprising: (a) computing a first target frame generation duration of at least one first frame according to first historical data relevant to frame generation of at least one first previous frame of the first frame, wherein frame generation of the first frame is required by an application; (b) deciding at least one first frame display time of the frame display device, according to the first target frame generation duration; and (c) the frame displaying device displaying the first frame respectively at the first frame display time; wherein the first target frame generation duration is computed according to a first minimum necessary frame generation duration in the first historical data.

### CROSS REFERENCE TO RELATED APPLICATIONS

This application claims the benefit of U.S. Provisional Application No. 63/672,277, filed on Jul. 17, 2024. The content of the application is incorporated herein by reference.

### BACKGROUND

The present application relates to a frame display method and a frame generation device, and particularly relates to a frame display method and a frame generation device which can ease jitter phenomenon under unsynchronized frame generation rate and display refresh rate.

In the related art, the frame generation rate (or named frame rate) required by an application is usually lower than the display refresh rate of a frame display device, which often causes jitter in the frame display device. The related art attempts to solve these problems with some technical methods. For example, in some technical methods, the frame generation rate and the frame refresh rate are synchronized by the same clock signal. However, this approach may have a larger display delay time, since even if the frame required by the app is completed in a shorter time, it still has to wait until the next clock cycle to be displayed. However, if the frame generation rate and the frame refresh rate are determined by different clock signals, for example, the frame required by the app is displayed immediately after the frame generation is completed, it may cause unstable frame display time when the frame generation time is unstable.

In addition to that, in another technical method, a system might allow the application to provide its target frame generation duration and an actual frame generation duration of a cycle of each frame and specify the display time of each frame. In such method, the system resource is controlled, such as a CPU and a GPU frequency, to achieve the requirement. However, such method is not guaranteed due to system power consumption and thermal, which affect actual frame generation duration.

### SUMMARY

One objective of the present application is to provide a frame display method which can reduce the display latency between the completeness of frame generation and frame display.

Another objective of the present application is to provide a frame display method which can reduce the display latency between the completeness of frame generation and frame display.

One embodiment of the present application discloses a frame display method, applied to a frame display device, comprising: (a) computing a first target frame generation duration of at least one first frame according to first historical data relevant to frame generation of at least one first previous frame of the first frame, wherein frame generation of the first frame is required by an application; (b) deciding at least one first frame display time of the frame display device, according to the first target frame generation duration; and (c) the frame displaying device displaying the first frame respectively at the first frame display time; wherein the first target frame generation duration is computed according to a first minimum necessary frame generation duration in the first historical data.

Another embodiment of the present application discloses a frame generation device comprising a storage device and a processing circuit. The storage device is configured to store at least one program. The processing circuit is configured to execute the program to execute a frame display method. The frame display method comprising: (a) computing a first target frame generation duration of at least one first frame according to first historical data relevant to frame generation of at least one first previous frame of the first frame, wherein frame generation of the first frame is required by an application; (b) deciding at least one first frame display time of the frame display device, according to the first target frame generation duration; and (c) controlling the frame displaying device to display the first frame respectively at the first frame display time; wherein the first target frame generation duration is computed according to a first minimum necessary frame generation duration in the first historical data.

In view of above-mentioned embodiments, the display latency between the completeness of frame generation and frame display can be reduced and stabilized, since the frame generation duration may be adjusted to be consistent.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a frame display method according to one embodiment of the present application.

FIG. 2 is a schematic diagram illustrating a frame display method according to another embodiment of the present application.

FIG. 3 is a schematic diagram illustrating a frame display method according to still another embodiment of the present application.

FIG. 4 is a schematic diagram illustrating operations of the frame display method according to one embodiment of the present application.

FIG. 5 is a block diagram illustrating a frame display device according to one embodiment of the present application.

FIG. 6 is a schematic diagram illustrating a frame display method according to one embodiment of the present application.

### DETAILED DESCRIPTION

In the following descriptions, several embodiments are

provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

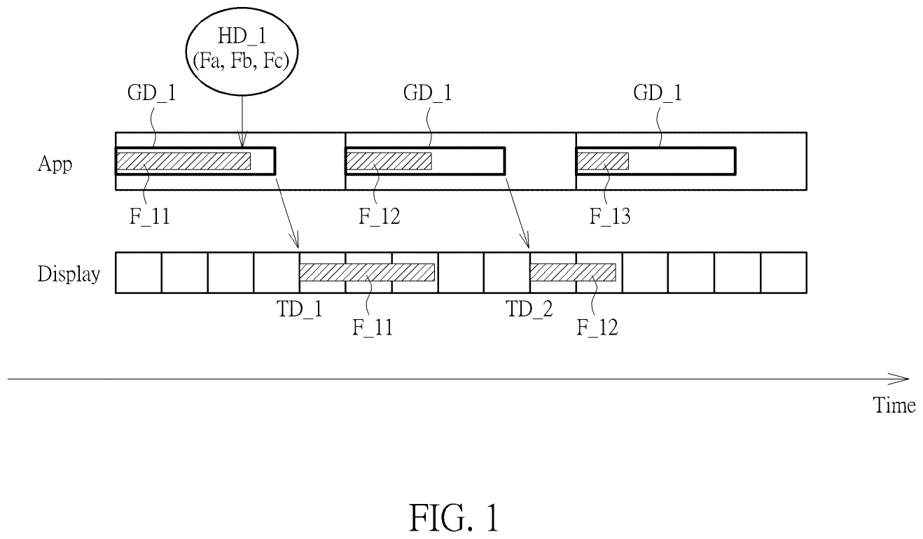

FIG. 1 is a schematic diagram illustrating a frame display method according to one embodiment of the present application. Please note, in the embodiment of FIG. 1, three first frames F_11, F_12 and F_13 are used as an example for explaining. However, the number of the first frames is not limited to three. As shown in FIG. 1, a first target frame generation duration GD_1 of at least one first frame F_11, F_12, F_13 is acquired, according to first historical data relevant to frame generation of at least one first previous frame (e.g., Fa, Fb, Fc . . . ) of the first frame F_11, F_12, F_13. In one embodiment, the first target frame generation duration GD_1 is computed according to a first minimum necessary frame generation duration in the first historical data. For example, if the frame generation durations of the first previous frames Fa, Fb, Fc are respectively Ta, Tb and Tc, and Ta<Tb<Tc. In such case, it can be inferred that Tc may be sufficient for the generation of all frames, thus Tc is selected as the first minimum necessary frame generation duration. In other words, the first minimum necessary frame generation duration is a frame generation duration which is long enough for frame generation of most or all frames.

Specifically, in the embodiment of FIG. 1, generation of the first frames F_11, F_12 and F_13 is completed in a duration marked by oblique lines, if no target frame generation duration is set according to the embodiments of the present application. In one embodiment, generation of the first frames is still completed according to the original duration, but after completion it will not be displayed until the first target frame generation duration GD_1 ends. In another embodiment, after the first target frame generation duration GD_1 is determined, the generation of the first frames F_11, F_12 and F_13 may be extended to be completed in the first target frame generation duration GD_1. Such embodiment may be performed when a frame generation device which performs the frame display method has enough computation power, for example, a CPU or a GPU of the frame generation device operates in a high operating level thus the frame can be generated quickly. After the first target frame generation duration GD_1 has been acquired, at least one first frame display time T_D1, T_D2 of the frame display device may be decided, according to the first target frame generation duration GD_1. Then, display the first frame F_11, F_12 respectively at the first frame display time TD_1, TD_2 . . . . Please note the first frame display time of the first frame F_13 is not shown in such case.

In one embodiment, the first frame display time of a target frame among the first frames F_11, F_12, is determined according to the first frame display time of a previous first frame of the target frame. For example, the first frame display time of the first frames F_12 (the target frame), is determined according to the first frame display time of the first frame F_11. Such mechanism may be used to avoid jitter. For example, if the first frame display times of the first frames F_11, F_12 are too close, the first frame display times of the first frame F_12 may be delayed to reduce the jitter between the first frames F_11, F_12.

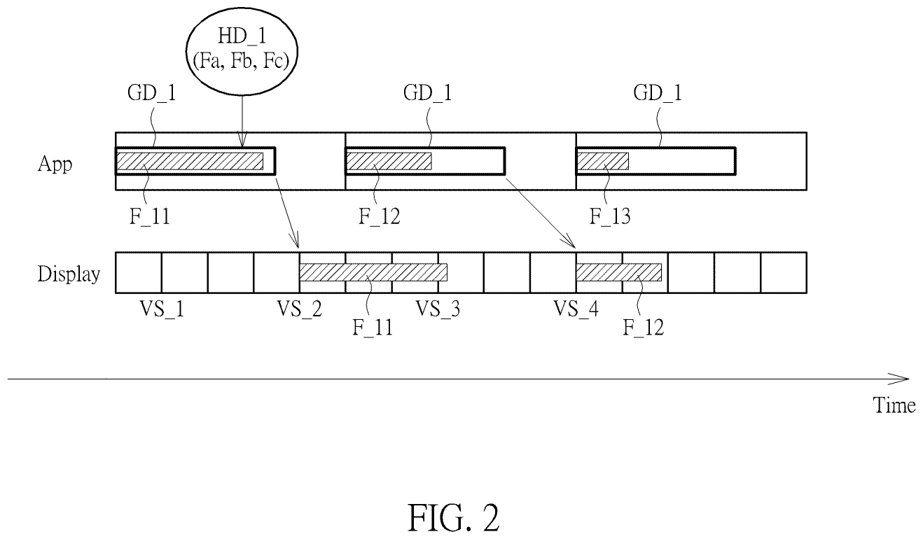

In one embodiment, the first target frame generation duration GD_1 is decided according to a Vsync signal of the frame display device. In one embodiment, a time point of a target Vsync signal of the frame display device is selected as the first frame display time. The target Vsync signal is a Vsync signal of the frame display device that is closest to an end of the first target frame generation duration GD_1 among all Vsync signals. For example, in the embodiment of FIG. 2, the Vsync signal VS_2 is the target Vsync signal since it is closest to the end of the first target frame generation duration GD_1 of the first frame F_11, among the Vsync signals VS_1, VS_2, VS_3, VS_4. Similarly, the Vsync signal VS 4 is also the target Vsync signal since it is closest to the end of the first target frame generation duration GD_1 of the first frame F_11, among the Vsync signals VS_1, VS_2, VS_3, VS_4.

In the embodiments of FIG. 1 and FIG. 2, if the ends of the first target frame generation duration GD_1 of different first frames are too close, the first frame display times of the first frames may be the same. In such case, only one of the first frames is displayed. Such mechanism may be regarded as: if the first frame display time of more than one target frames among the first frame are identical, the frame display method only displays one of the target frames. For example, in the embodiment of FIG. 1, if the first frame display times of the first frames F_12, F_13 (the target frame), only one of the first frames F_12, F_13 is displayed.

In one embodiment, start times of the frame generation of the first frames F_11, F_12 and F_13 are acquired. The first target frame generation duration GD_1 may be computed according to the start time. Various methods can be applied to compute the start time. For example, in the application Ser. No. 19/245,436, methods of acquiring the start time of frame generations are disclosed. However, the scope of the present application is not limited to these methods. More specifically, if the start times are acquired, and a length of the first target frame generation duration GD_1 is acquired, the end of the first target frame generation duration GD_1 can be acquired.

In one embodiment, the frame generation of the first frames F_11, F_12 is performed by the frame display device. In such case, the first target frame generation duration GD_1 is further computed according to a device state of the frame display device. In one embodiment, the device state comprises a power state or a thermal state of the frame display device. For example, if the power state means the frame display device has sufficient state, the operation levels of a CPU or a GPU, which are used to generate the first frames F_11, F_12, F_13 may be set as high as possible. By this way, lengths the first target frame generation duration GD_1 may be shortened. For another example, under the premise that the frame generation device does not overheat, the operation levels of the CPU and GPU can be set as high as possible to shorten the first target frame generation duration GD_1.

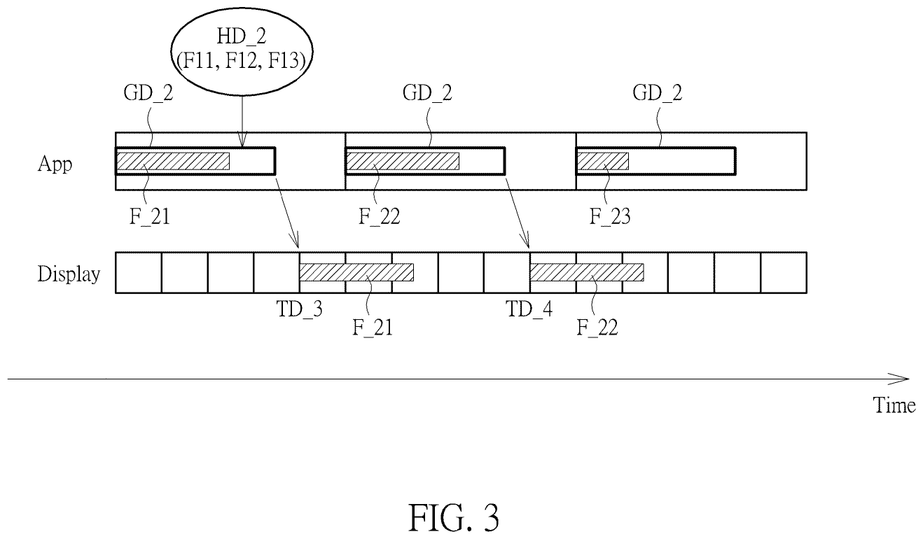

The values of the target frame generation duration may be updated periodically or non-periodically. FIG. 3 is a schematic diagram illustrating a frame display method according to still another embodiment of the present application. As shown in FIG. 3, a second target frame generation duration GD_2 of at least one second frame F_21, F_22, F_23 according to second historical data HD_2 relevant to frame generation of at least one second previous frame of the second frames F_21, F_22 and F_23. In one embodiment, the second previous frame may comprise the above-mentioned first frames F_11, F_12 and F_13. In other words, the second frames F_21, F_22 and F_23 may be frames after the first frames F_11, F_12 and F_13.

Following the above-mentioned rules, second frame display times TD_3, TD_4 are computed according to the second target frame generation duration GD_2. After that, the second frames F_21, F_22 are respectively displayed at the second frame display time TD_3, TD_4. The second target frame generation duration GD_2 is computed according to a second minimum necessary frame generation duration in the second historical data HD_2.

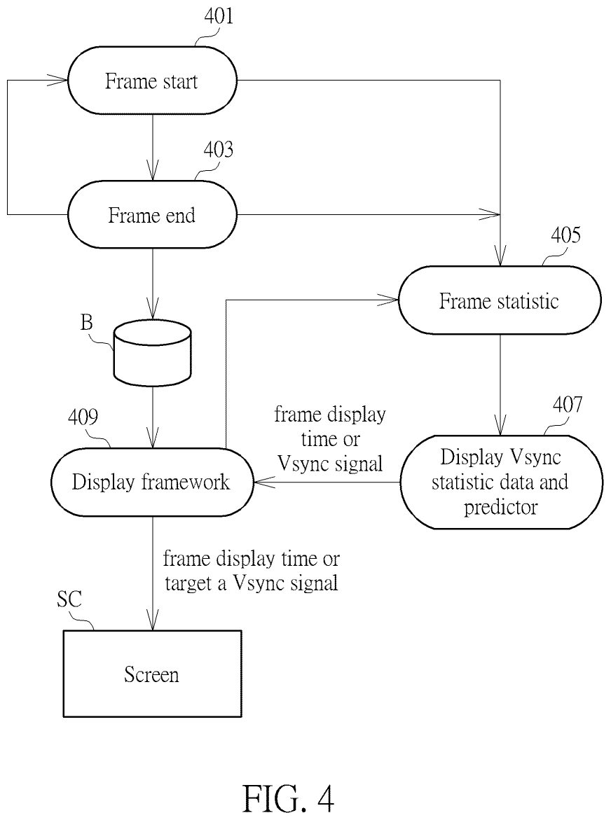

FIG. 4 is a schematic diagram illustrating operations of the frame display method according to one embodiment of the present application. In the steps 401 and 403, the frame generation respectively starts and ends, and then frames are buffered to a buffer B. The step 405 collects frame information or buffer information from steps 401, 403, 409, such as frame ID, buffer ID, or timestamps. The step 407 computes the frame display time or select a time point of the Vsync signal as the frame display time. The step 409 sets the frame display time to the screen SC or targets a Vsync signal as the frame display time.

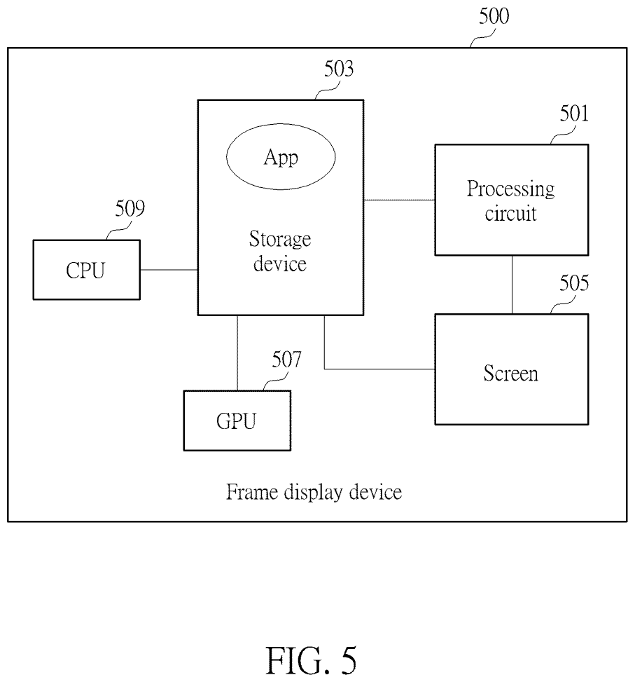

FIG. 5 is a block diagram illustrating a frame display device 500 according to one embodiment of the present application. Please note, the above-mentioned embodiments can be implemented by other devices rather than limited to the frame display device 500. The frame display device 500 can be any device which can display frames, such as a mobile phone or a tablet computer. As shown in FIG. 5, the frame display device 500 comprises a processing circuit 501, a storage device 503 and a screen 505.

The above-mentioned application is installed to the storage device 503. The application can also be installed to a storage device which is different from the storage device 503. Also, the storage device 503 may store at least one program, and the processing circuit 501 executes the program to perform the above-mentioned embodiments. Additionally, the frame display device 500 may comprises at least one graphic component which is used to generate frames according to the requirement from the application, such as the GPU 507 or the CPU 509. In one embodiment, the processing circuit 501 is integrated to the CPU 509. The processing circuit 501, the storage device 503 and the graphic component may be regarded as a frame generation device.

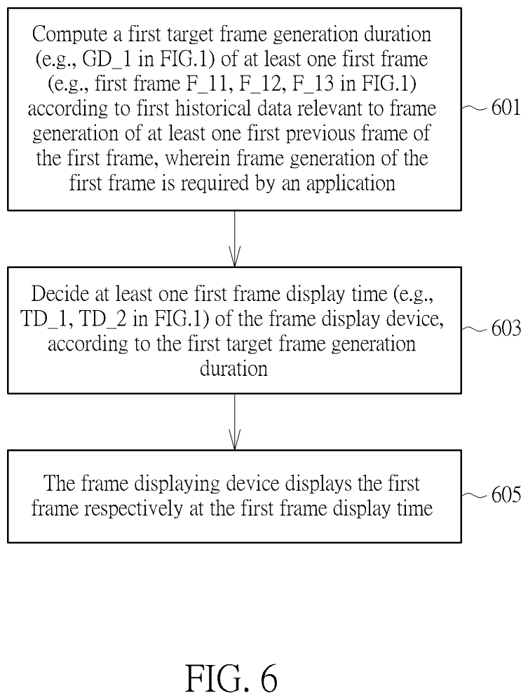

FIG. 6 is a schematic diagram illustrating a frame display method according to one embodiment of the present application. The frame display method in FIG. 6, which corresponds to FIG. 1, comprises following steps:

### Step 601

Compute a first target frame generation duration (e.g., GD_1 in FIG. 1) of at least one first frame (e.g., first frame F_11, F_12, F_13 in FIG. 1) according to first historical data relevant to frame generation of at least one first previous frame of the first frame, wherein frame generation of the first frame is required by an application.

### Step 603

Decide at least one first frame display time (e.g., TD_1, TD_2 in FIG. 1) of the frame display device, according to the first target frame generation duration.

### Step 605

The frame displaying device displays the first frame respectively at the first frame display time.

The first target frame generation duration is computed according to a first minimum necessary frame generation duration in the first historical data. As above-mentioned, the first minimum necessary frame generation duration is a frame generation duration which is long enough for frame generation of most or all frames.

If the frame display method corresponds to FIG. 3, the frame display method may further comprise: computing a second target frame generation duration (e.g., GD_2 in FIG. 3) of at least one second frame (e.g., F_21, F_22, F_23 in FIG. 3) according to second historical data relevant to frame generation of at least one second previous frame of the second frame; deciding a second frame display time (e.g., TD_3, TD_4 in FIG. 3) of the frame display device, according to the second target frame generation duration; and displaying the second frame respectively at the second frame display time; wherein the second target frame generation duration is computed according to a second minimum necessary frame generation duration in the second historical data.

In one embodiment, the second previous frame comprises the first frame.

In view of above-mentioned embodiments, the display latency between the completeness of frame generation and frame display can be reduced and stabilized, since the frame generation duration may be adjusted to be consistent.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frame display method, applied to a frame display device, comprising:
(a) computing a first target frame generation duration of at least one first frame according to first historical data relevant to frame generation of at least one first previous frame of the first frame, wherein frame generation of the first frame is required by an application;
(b) deciding at least one first frame display time of the frame display device, according to the first target frame generation duration; and
(c) the frame displaying device displaying the first frame respectively at the first frame display time;
wherein the first target frame generation duration is computed according to a first minimum necessary frame generation duration in the first historical data.

2. The frame display method of claim 1, further comprising:
acquiring a start time of the frame generation of the first frame, wherein the step (a) computes the first target frame generation duration according to the start time.

3. The frame display method of claim 1, wherein the frame generation of the first frame is performed by the frame display device, wherein the step (a) further computes the first target frame generation duration according to a device state of the frame display device.

4. The frame display method of claim 3, wherein the device state comprises a power state or a thermal state of the frame display device.

5. The frame display method of claim 1, wherein the step (b) decides the first frame display time of a target frame among the first frames, according to the first frame display time of a previous first frame of the target frame.

6. The frame display method of claim 1, further comprising:
(d) computing a second target frame generation duration of at least one second frame according to second historical data relevant to frame generation of at least one second previous frame of the second frame;
(e) deciding a second frame display time of the frame display device, according to the second target frame generation duration; and
(f) displaying the second frame respectively at the second frame display time;
wherein the second target frame generation duration is computed according to a second minimum necessary frame generation duration in the second historical data.

7. The frame display method of claim 6, wherein the second previous frame comprises the first frame.

8. The frame display method of claim 1, wherein the step (b) decides a time point of a target Vsync signal of the frame display device as the first frame display time, wherein the target Vsync signal is a Vsync signal of the frame display device that is closest to an end of the first target frame generation duration among all Vsync signals.

9. The frame display method of claim 1, wherein if the first frame display time of more than one target frames among the first frame are identical, the frame display method only displays one of the target frames.

10. A frame generation device, installed with an application, comprising:
a storage device, configured to store at least one program;
a processing circuit, configured to execute the program to execute a frame display method, the frame display method comprising:
(a) computing a first target frame generation duration of at least one first frame according to first historical data relevant to frame generation of at least one first previous frame of the first frame, wherein frame generation of the first frame is required by an application;
(b) deciding at least one first frame display time of the frame display device, according to the first target frame generation duration; and
(c) controlling the frame displaying device to display the first frame respectively at the first frame display time;
wherein the first target frame generation duration is computed according to a first minimum necessary frame generation duration in the first historical data.

11. The frame generation device of claim 10, wherein the frame display method further comprises:
acquiring a start time of the frame generation of the first frame, wherein the step (a) computes the first target frame generation duration according to the start time.

12. The frame generation device of claim 10, wherein the step (a) further computes the first target frame generation duration according to a device state of the frame generation device.

13. The frame generation device of claim 12, wherein the device state comprises a power state or a thermal state of the frame generation device.

14. The frame generation device of claim 10, wherein the step (b) decides the first frame display time of a target frame among the first frames, according to the first frame display time of a previous first frame of the target frame.

15. The frame generation device of claim 10, wherein the frame display method further comprises:
(d) computing a second target frame generation duration of at least one second frame according to second historical data relevant to frame generation of at least one second previous frame of the second frame;
(e) deciding a second frame display time of the frame display device, according to the second target frame generation duration; and
(f) displaying the second frame respectively at the second frame display time;
wherein the second target frame generation duration is computed according to a second minimum necessary frame generation duration in the second historical data.

16. The frame generation device of claim 15, wherein the second previous frame comprises the first frame.

17. The frame generation device of claim 10, wherein the step (b) decides a time point of a target Vsync signal of the frame display device as the first frame display time, wherein the target Vsync signal is a Vsync signal of the frame display device that is closest to an end of the first target frame generation duration among all Vsync signals.

18. The frame generation device of claim 10, wherein if the first frame display time of more than one target frames among the first frame are identical, the frame generation device only displays one of the target frames.
